(19) United States
(12) Patent Application Publication
(10) Pub. No.: US 2007/0138777 A1
(43) Pub. Date: Jun. 21, 2007

(54) AIR BAG SYSTEM

(75) Inventor: Hyung Kwan OH, Seoul (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Yongin-shi (KR)

(21) Appl. No.: 11/425,888

(22) Filed: Jun. 22, 2006

(30) Foreign Application Priority Data
Dec. 16, 2005 (KR) 1020050124743

(51) Int. Cl. B60R 21/26

(52) U.S. Cl. 280/740; 280/730.2

(57) ABSTRACT

An air bag system is disclosed. The air bag system comprises a cushion deployed by gas from an inflator in the event of a vehicle collision, for protecting a passenger, a gas guider provided between the cushion and the inflator, for guiding the gas from the inflator to the cushion, and a guide bag provided at one side of the cushion, and deployed by the gas guided by the gas guider earlier than the cushion is so that the cushion is deployed without interference from other adjacent components. The cushion is smoothly deployed without interference from other adjacent components, thereby improving the deployment performance of the cushion. A ramp used for a prior art air bag system is omitted, thus the air bag system is formed in an overall simple structure. The unit cost and weight of the air bag system are lowered, and it is unnecessary to acquire a space for installing the ramp, thereby improving the design freedom of the air bag system.

This Nonprovisional application claims priority under 35 U.S.C. § 119(a) on Patent Application No. 10-2005-0124743 filed in Korea on Dec. 16, 2005, the entire contents of which are hereby incorporated by reference.

### BACKGROUND OF THE INVENTION

1. Field of the Invention

The present invention relates to an air bag system, and more particularly to, an air bag system which can prevent interference between a cushion and other adjacent components upon deployment of the cushion.

2. Description of the Background Art

Generally, an air bag system is one of the safety devices installed for the purpose of saving a passenger's life and protecting their body at the time of a vehicle collision. The air bag system includes a driver seat air bag system, a passenger seat air bag system, a curtain air bag system, etc.

The driver seat air bag system is mounted on a steering handle for the purpose of protecting the front of a driver in a driver's seat, the passenger air bag system is installed on an instrument panel on the front side of a passenger's seat for the purpose of protecting the front of a passenger in the passenger's seat, and the curtain air bag system is installed on a side roof rail for the purpose of protecting the sides of a passenger.

In the curtain air bag system, a cushion is deployed downward in a curtain shape along the inner side faces of a side door upon side collision of a vehicle.

FIG. 1 is a perspective view illustrating a curtain air bag system according to the prior art. FIG. 2 is an exploded perspective view illustrating the main parts of the curtain air bag system according to the prior art.

Referring to FIGS. 1 and 2, the prior art curtain air bag system will be described.

An inflator 2 is installed at one end of a side roof rail, a cushion 6 deploying downward in a curtain shape is stored inside an air bag cover 4 installed longitudinally along the side roof rail, and a gas guider 8 guiding gas from the inflator 2 to the inside of the cushion 6 is provided between the cushion 6 and the inflator 2.

The top portions of the air bag cover 4 and of the cushion 6 are fastened and secured to the side roof rail by a plurality of fastening members 10.

In the prior art curtain air bag system 1 thus constructed, upon side collision of a vehicle, gas from the inflator 2 is supplied to the cushion 6 through the gas guider 8, and the cushion 6 is deployed downward along the sides of the interior of the vehicle after the lower portion of the air bag cover 4 is torn by the gas pressure of the gas guider 8.

However, the prior art curtain air bag system has such a structure in which a front pillar trim, a center pillar trim 12, and a rear pillar trim, defining the sides of a vehicle body are provided on the lower side of the side roof rail, and the top portion of the center pillar trip 12 is located further inward of the vehicle than the curtain air bag system 1. Hence, there is a problem that the cushion 6 is interfered by the top portion of the center pillar trim 12 upon deployment of the cushion 5, which leads to an incomplete deployment of the cushion 6 or a rupture thereof, thereby damaging the cushion 6.

To overcome the aforementioned problems, in the prior art curtain air bag system 1, as illustrated in FIG. 1, a ramp 14 preventing interference between the cushion 6 and the center pillar trim 12 is installed on the region of the cushion facing the center pillar trim 12.

One side of the ramp 14 is placed on top of the center pillar trim 12 by a deployment pressure upon deployment of the cushion 6, and the cushion 6 is deployed without being stopped by the top portion of the center pillar trim 12 by means of the one side of the ramp 14.

However, the curtain air bag system 1 with the ramp 14 was problematic in that the addition of the ramp 14 increases the cost of parts and requires the mounting process of the ramp 14, and various types of ramps 14 are manufactured separately according to the installation condition of the curtain air bag system 1.

Particularly, since the curtain air bag system 1 is installed on a side roof rail of a narrow size, there is a problem that it is difficult to acquire an installation space due to the addition of the ramp 14, thereby lowering the design freedom of the air bag system.

Additionally, because the curtain air bag system 1 has such a structure in which the interference between the cushion 6 and the center pillar trim 12 is avoided by the ramp 14, the deployment of the cushion 6 is interfered by the ramp 14 unless the ramp 14 is precisely operated at an appropriate time. Thus, there is a problem that the shape and weight of the ramp 14 have to be designed very precisely for manufacture according to the installation condition of the air bag system.

### SUMMARY OF THE INVENTION

The present invention has been made in an effort to solve the above-described prior art problems, and to provide an air bag system which has a guide bag provided on a cushion, and can deploy a cushion without interference from other components by means of the guide bag.

Additionally, the present invention provides an air bag system which can reduce the cost and weight of the air bag system and simplify the installation process by omitting a ramp preventing interference between a cushion and other components upon deployment of the cushion, and which can improve design freedom by easily acquiring an installation space.

Additionally, the present invention provides an air bag system which can serve the function of deploying a cushion as an initial deployment position of the cushion is changed to a position where interference from other components can be avoided by means of a guide bag before deployment of the cushion

To achieve these and other advantages and in accordance with the purpose of the present invention, as embodied and broadly described herein, there is provided an air bag system, comprising: a cushion deployed by gas from an inflator in the event of a vehicle collision, for protecting a passenger; a gas guider provided between the cushion and the inflator, for guiding the gas from the inflator to the cushion; and a guide bag provided at one side of the cushion, and deployed by the gas guided by the gas guider earlier than the cushion is so that the cushion is deployed without interference from other adjacent components.

The inflator is connected to one side of the gas guider, and first and second gas release holes for releasing the gas into the cushion and the guide bag are formed at the other side of the gas guider.

The second gas release hole is larger than the first gas release hole, or formed in plural, concentrated at one region of the gas guider.

The foregoing and other objects, features, aspects and advantages of the present invention will become more apparent from the following detailed description of the present invention when taken in conjunction with the accompanying drawings.

### BRIEF DESCRIPTION OF THE DRAWINGS

In the drawings:

FIG. 1 is a perspective view illustrating a curtain air bag system according to the prior art;

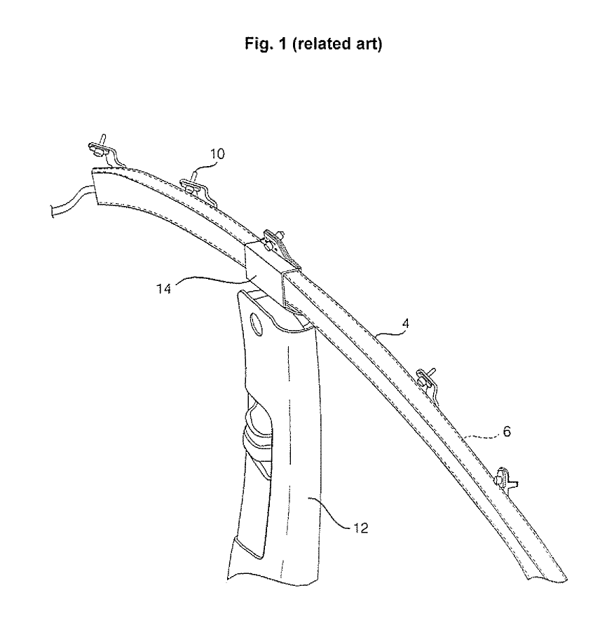

FIG. 2 is an exploded perspective view illustrating the main parts of the curtain air bag system according to the prior art;

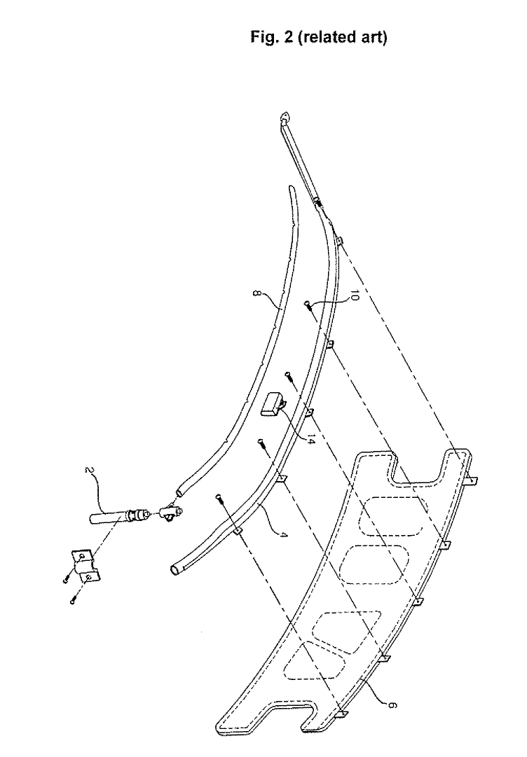

FIG. 3 is a configuration diagram schematically illustrating a curtain air bag system being installed on a vehicle according to a first embodiment of the present invention;

FIG. 4 is an exploded perspective view illustrating the main parts of the curtain air bag system according to the first embodiment of the present invention;

FIG. 5 is a perspective view illustrating a deployed state of the curtain air bag system according to the first embodiment of the present invention;

FIG. 6 is a perspective view illustrating a cushion of and a guide bag of the curtain air bag system according to the first embodiment of the present invention;

FIG. 7 is an exploded perspective view illustrating the main parts of the curtain air bag system according to a second embodiment of the present invention; and

FIG. 8 is an exploded perspective view illustrating the main parts of the curtain air bag system according to a third embodiment of the present invention.

### DETAILED DESCRIPTION OF THE PREFERRED EMBODIMENTS

Hereinafter, exemplary embodiments of the present invention will now be described with reference to the accompanying drawings.

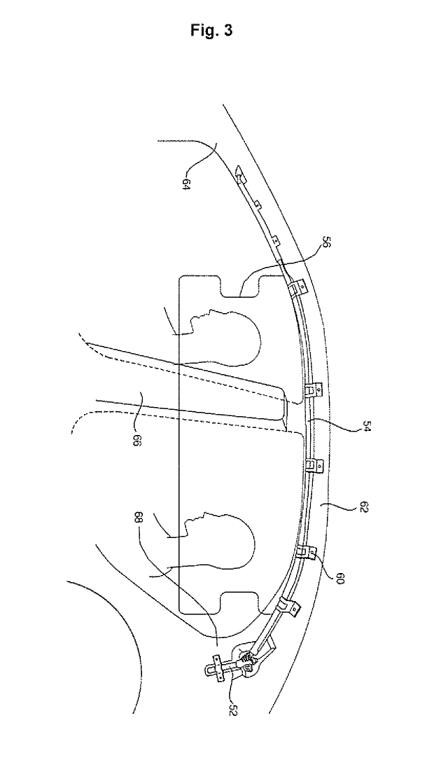

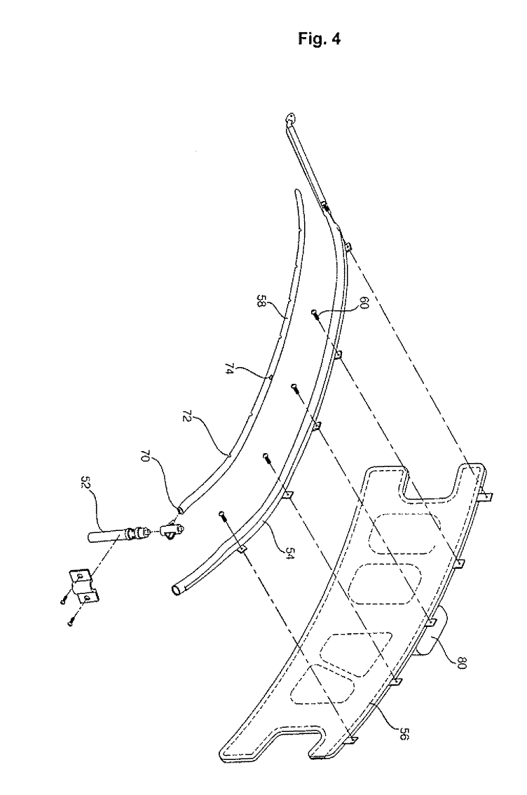

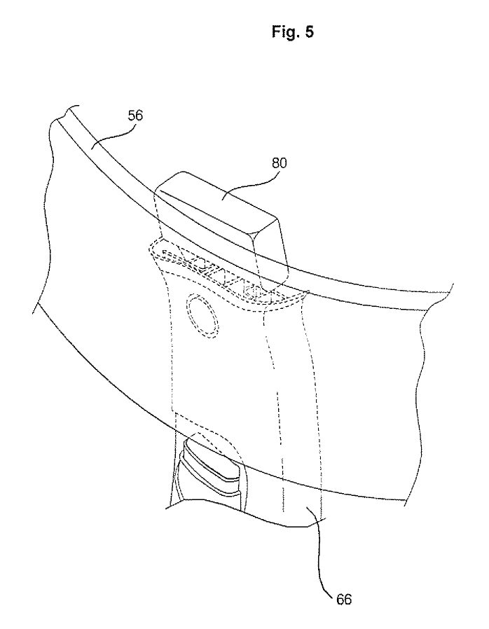

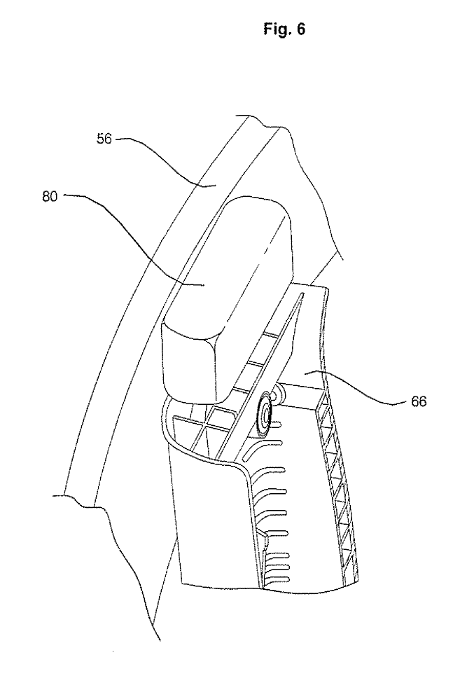

FIG. 3 is a configuration diagram schematically illustrating a curtain air bag system being installed on a vehicle according to a first embodiment of the present invention. FIG. 4 is an exploded perspective view illustrating the main parts of the curtain air bag system according to the first embodiment of the present invention. FIG. 5 is a perspective view illustrating a deployed state of the curtain air bag system according to the first embodiment of the present invention. FIG. 6 is a perspective view illustrating a cushion of and a guide bag of the curtain air bag system according to the first embodiment of the present invention.

As illustrated in FIGS. 3 to 6, the curtain air bag system according to the present invention includes: an inflator 52 installed at one end of a side roof rail 62, for releasing gas in the event of a vehicle collision; an air bag cover 54 longitudinally installed along the side roof rail 62; a curtain-shaped cushion 56 stored in the air bag cover 54 and deployed downward along the sides of the interior of the vehicle by the gas from the inflator 52; a gas guider 58 provided between the inside of the cushion 56 and the inflator 52, for guiding the gas from the inflator 52 to the cushion 56; and a guide bag 80 formed at one side of the cushion 56 so as to be deployed by the gas of the gas guider earlier than the cushion 56 is so that the cushion 56 is deployed without interference from other adjacent components.

The cushion 56 is longitudinally disposed, being folded inside the air bag cover 54, and the top portions of the air bag cover 54 and the cushion 56 are mounted on the side roof rail 62 by a plurality of fastening members 60.

At this time, a front pillar trim 64, a center pillar trim 66, and a rear pillar trim 68, defining the sides of the vehicle, are disposed on the lower side of the side roof rail 62 so as to be spaced apart in a vertical direction, and the top portion of the center pillar trim 66 is protruded more inward of the vehicle than the cushion 56 is.

The gas guider 58 is a pipe-shaped member one side of which is connected to the inflator 52, and the other side of which is connected to the cushion 56 and the inside of the guide bag 80. At the one side thereof, a gas inlet 70 for introducing the gas from the inflator 52, and at the other side thereof, first and second gas release holes 72 and 74 for releasing the gas into the cushion 56 and the guide bag 80 are formed.

The gas guider 58 as described above is longitudinally disposed along the side roof rail 62 inside the cushion 56.

The first gas release hole 72 is formed in plural on the other side of the gas guider 58 so as to be spaced apart in a longitudinal direction, such that the gas of the gas guider 58 can be uniformly supplied into the cushion 56.

The second gas release hole 74 has a larger area for gas release than the first gas release holes 72 have, such that the guide bag 80 is deployed by the gas of the gas guider 58 earlier than the cushion 56 is, thereby increasing the amount of gas released into the guide bag 80.

The guide bag 80 is a member for changing an initial deployment position of the cushion 56 to a position where there is no interference from other adjacent parts, and is formed integral with the cushion 56 and disposed on the side roof rail in a folded state along with the cushion 56.

Although such a guide bag 80 may be formed in plural on the cushion 56, this embodiment will be described with respect to a case where a single guide bag 80 is formed on the cushion 56.

At a connecting region between the guide bag 80 and the cushion 56, a gas supply path is formed at a position facing the second gas release hole 74 of the gas guider 58, such that the gas released through the second gas release hole 74 is introduced into the guide bag 80 through the gas supply path.

The gas supply path is a hole formed at the connecting region between the guide bag 80 and the cushion 56, or a tubular flow passage extending to the second gas release hole from the connecting region between the guide bag 80 and the cushion 56.

On the lower side of the side roof rail 62, the front pillar trim 64, the center pillar trim 66, and the rear pillar trim 68 are sequentially disposed in a vertical direction to define the sides of the vehicle. The center pillar trim 66 is disposed so as to be protruded inward of the vehicle due to its thickness, such that the top portion of the center pillar trim 66 is located more inward of the vehicle than the cushion 56 is. Therefore, in order to prevent the cushion 56 from interfered by the top portion of the center pillar trim 66 upon deployment of the cushion 56, the interference region of the cushion 56 facing the center pillar trim 66 is moved by the guide bag 80 more inward of the vehicle than the top portion of the center pillar trim 66 is.

The guide bag 80 as described above is formed integral on the back surface of the interference region of the cushion 56 facing the center pillar trim 66. The guide bag 80 is deployed toward the side roof rail so that the cushion 56 is moved to the interior of the vehicle, and is formed longer than the thickness of the top portion of the center pillar trim 66 so that the cushion 56 is located more inward of the vehicle than the center pillar trim 66 is.

The operation and operational effects of the curtain air bag system thus constructed according to the present invention will now be described.

First, the inflator 52 generates gas by a sensing signal from an impact sensor (not shown) installed on the vehicle in the event of a vehicle collision, and the gas from the inflator 52 flows into the cushion 56 along the gas guider 58.

The gas in the gas guider 58 is uniformly released into the cushion 56 through the plurality of first gas release holes 72, and released into the guide bag 80 through the second gas release hole 74.

Sine the second gas release holes 74 are larger than the first gas release hole 72, and the guide bag 80 is smaller than the cushion 56, the guide bag 80 is deployed by the gas of the gas guider 58 earlier than the cushion 56 is.

That is, although the gas is simultaneously supplied to the guide bag 80 and the cushion 56 by the first and second gas release holes 72 and 74, the guide bag 80 is supplied with the gas through the second gas release hole 74 more rapidly as compared to the cushion 56, to thus change an initial deployment position of the cushion 56 earlier than the cushion 56 is deployed.

The guide back 80 as above is deployed toward the side roof rail 62 to thus push the interference region of the cushion facing the center pillar trim 66 to the interior side of the vehicle, and is deployed longer than the thickness of the top portion of the center pillar trim 66, and thus the interference region of the cushion 56 facing the center pillar trim 66 is located more inward of the vehicle than the top portion of the center pillar trim 66 is.

At this time, the cushion 56 is in an initial stage when deployment begins by the gas from the first gas release holes 72, that is, the cushion 56 is not deployed in a full scale unlike the guide bag 80.

Accordingly, in the case that the cushion 56 is deployed by the gas released from the plurality of first gas release holes 72, the lower portion of the air bag cover 54 is torn out, and thereafter the cushion 56 is easily deployed downward along the sides of the vehicle without interference from the top portion of the center pillar trim 66.

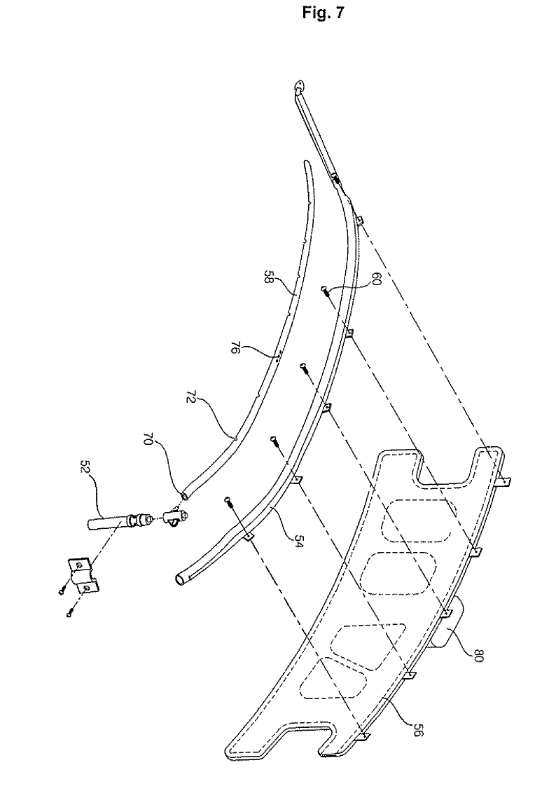

FIG. 7 is an exploded perspective view illustrating the main parts of the curtain air bag system according to a second embodiment of the present invention.

For reference, the same or similar components as those shown in the first embodiment are indicated by the same reference numerals, and a detailed description thereof will be omitted.

In the curtain air bag system according to the second embodiment of the present invention, as illustrated in FIG. 7, a plurality of second gas release holes 76 are formed on the gas guider 58. The plurality of second gas release holes 76 are formed, concentrated at one part of the gas guider 58 facing the guide bag 80, and the other elements are formed same as those of the first embodiment described above.

In other words, the plurality of first gas release holes 72 are disposed on the gas guider 58 in a longitudinal direction in a manner to be spaced part from each other, and the plurality of second gas release holes 76 are formed, concentrated at one part of the gas guider 58, thus the guide bag 80 is deployed earlier than the cushion 56 is.

The plurality of second gas release holes 76 are formed in various directions at a part of the gas guider 58 so that gas is supplied into the guide bag 80 in different directions from each other.

Once gas is released in various directions through the plurality of second gas release holes 76, the gas supply is optimized depending on the shape and deployment direction of the guide bag 80, thereby improving the deployment performance of the guide bag 80.

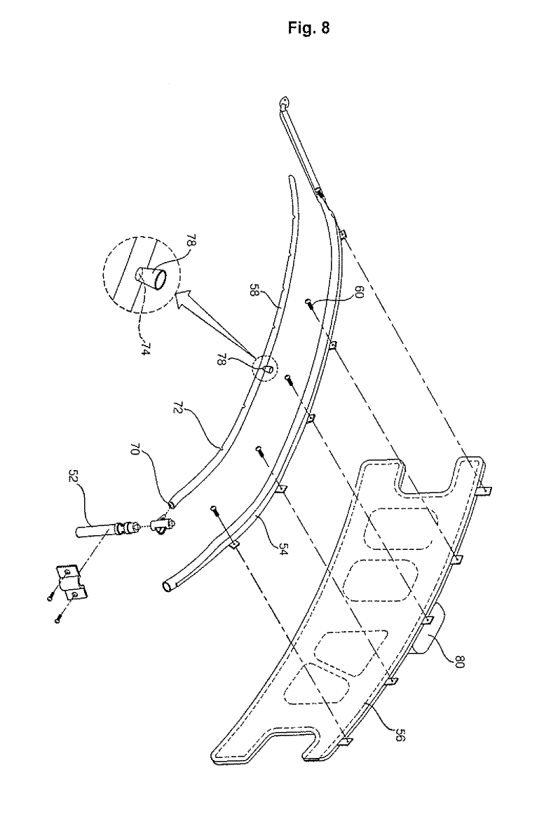

FIG. 8 is an exploded perspective view illustrating the main parts of the curtain air bag system according to a third embodiment of the present invention.

For reference, the same or similar components as those shown in the first embodiment are indicated by the same reference numerals, and a detailed description thereof will be omitted.

In the curtain air bag system according to the third embodiment of the present invention, as illustrated in FIG. 8, a diffuser 78 for increasing the amount of gas released and guiding the gas into the guide bag 80 is formed on the second gas release hole 74 of the gas guider 58, and the other elements are formed same as those of the first embodiment described above.

The diffuser 78 is formed in various structures depending on the design condition of the air bag system. That is, the diffuser 78 is formed in a structure in which the inlet is expanded or constricted as compared to the outlet, thereby increasing the amount of gas released, or formed in a structure in which the middle portions of the inlet and outlet are bent to one side, thereby making it possible to efficiently supply gas into the guide bag 80.

In other words, the inlet and outlet of the diffuser 78 are varied in size according to the flow velocity of the gas released to the second gas release hole 74 so that the amount of gas released through the second gas release hole 74 can be increased to the maximum, and the diffuser 78 is properly bent according to the position of the guide bag 80 formed on the cushion 56.

In this embodiment, the outlet of the diffuser 78 is larger than the inlet thereof.

Consequently, the guide bag 80 is improved in the deployment performance by means of the diffuser 78.

While the present invention has been described with reference to the embodiments illustrated in the drawings, it will be apparent to those skilled in the art that the present invention is not limited to the foregoing embodiments and the drawings, and various changes and modifications can be made therein without departing from the scope of the invention.

That is, it is needless to say that the present invention is applicable to a driver seat air bag system, a passenger seat air bag system, etc., as well as to the curtain air bag system.

Moreover, it is needless to say that guide bags of various structures are provided at various positions of the cushion, respectively, or the plurality of guide bags may have a different deployment speed.

In the thus-constructed air bag system as above, gas from the inflator is injected into the guide bag earlier to thus change an initial deployment position of the cushion to a position where there is no interference from other adjacent components. Accordingly, the cushion is smoothly deployed without interference from other adjacent components, thereby improving the deployment performance of the cushion, and damage of the cushion is prevented, thereby obtaining the reliability of the air bag system.

Furthermore, since interference between the cushion and other components is prevented by the guide bag formed on the cushion, the ramp used for the prior art air bag system is omitted. Accordingly, the air bag system is formed in an overall simple structure.

Furthermore, because the ramp preventing interference between the cushion and other components is omitted, the unit cost and weight of the air bag system are lowered, the installation process of the ramp is omitted, and it is unnecessary to acquire a space for installing the ramp, thereby improving the design freedom of the air bag system.

Furthermore, the air bag system can serve the function of deploying the cushion because the cushion is deployed, with interference between the cushion and other components avoided in advance by the guide bag.

What is claimed is:

1. An air bag system, comprising:
a cushion deployed by gas from an inflator in the event of a vehicle collision, for protecting a passenger;
a gas guider, provided between the cushion and the inflator, to guide the gas from the inflator to the cushion; and
a guide bag provided at one side of the cushion, and deployed by the gas guided by the gas guider earlier than the cushion, so that the cushion is deployed without interference from other adjacent components.

2. The air bag system of claim 1, wherein the inflator is connected to one side of the gas guider, and first and second gas release holes, to release the gas into the cushion and the guide bag are formed at the other side of the gas guider.

3. The air bag system of claim 2, wherein the second gas release hole is larger than the first gas release hole.

4. The air bag system of claim 2, wherein the second gas release hole is formed in a plurality and is concentrated at one region of the gas guider.

5. The air bag system of claim 2, wherein a diffuser, that increases the amount of gas released and guides the gas into the guide bag, is formed on the second gas release hole.

6. The air bag system of claim 1, wherein the guide bag is formed integral with the cushion.

7. The air bag system of claim 1, wherein the guide bag is formed in a plurality at different positions of the cushion.

8. The air bag system of claim 1, wherein the guide bag changes an initial deployment position of the cushion to a position where the cushion is deployable without interference from other adjacent components.

9. The air bag system of claim 1, wherein the air bag system is a curtain air bag system which deploys the cushion downward in a curtain shape along the inner side faces of the vehicle by the gas of the gas guider by having the cushion installed on a side roof rail of the vehicle,
the guide bag being provided at a region of the cushion facing the center pillar trim so that the cushion is not interfered by the center pillar trim upon deployment of the cushion.

10. The air bag system of claim 9, wherein the guide bag is provided on the back surface of the cushion facing the side roof rail so that an initial deployment position of the cushion is moved more inward of the vehicle than the center pillar trim is.

11. The air bag system of claim 10, wherein the guide bag is deployed toward the side roof rail so as to push the cushion to the interior side of the vehicle.

12. The air bag system of claim 11, wherein the guide bag is deployed longer than the thickness of the center pillar trim.
